(19) United States
(12) Patent Application Publication
(10) Pub. No.: US 2016/0184952 A1
(43) Pub. Date: Jun. 30, 2016

(54) RECOVERY ROTATIONAL SPEED FOR DIAMOND-TIPPED CORE DRILLING DEVICES AFTER A TEMPERATURE SWITCH-OFF (OVERHEATING OF THE MOTOR)

(71) Applicant: HILTI AKTIENGESELLSCHAFT, Schaan (LI)

(72) Inventors: Fabian Kabza, Muenchen (DE); Oliver Koslowski, Puergen (DE); Egon Koenigbauer, Eichendorf (DE); Konrad Lieb, Bad Ragaz (CH); Markus Forstner, Landsberg (DE); Torsten Asmus, Landsberg (DE)

(21) Appl. No.: 14/912,398

(22) PCT Filed: Aug. 12, 2014
(86) PCT No.: PCT/EP2014/067195

§ 371 Date: Feb. 16, 2016

(30) Foreign Application Priority Data
Aug. 19, 2013 (EP) EP13180865.1

(51) Int. Cl. B23Q 11/14; B23Q 15/12; B25F 5/00

(52) U.S. Cl. CPC B23Q 11/14; B25F 5/00; B23Q 15/12

(57) ABSTRACT

A method is provided for controlling a power tool (1) when a material (W) is being worked, including the steps:
the rotational speed of a drive (20) of the power tool is set to a first value;
a first temperature value is measured;
the first temperature value is compared to a pre-specified threshold value;
the rotational speed of the drive (20) is reduced from the first value to a second value if the first temperature value exceeds the pre-specified threshold value for a pre-specified first period of time;
a second temperature value is measured;
the second temperature value is compared to the pre-specified threshold value; and
the rotational speed of the drive (20) is raised from the second value to the first value if the second temperature value has fallen below the pre-specified threshold value for a pre-specified second period of time.

The present invention relates to a method to control a power tool when a material is being worked.

### BACKGROUND

When a material is being worked by a power tool such as, for example, a hammer drill, a power drill, a circular saw or the like, the power tool can experience a temperature-related failure if it has been in use intensively or for a long time. In order to generate a high torque or a high performance output, the power tool drive, which is normally in the form of an electric motor, requires a high current or voltage from the battery or (depending on the application) from the power network. As a result, the electric motor configured as the drive generates a great deal of heat.

Even though almost all modern electric motors have a cooling means that is designed to protect the electric motor against excessive temperatures and against the possible resultant damage, the cooling capacity of these cooling means is often limited because of the space restrictions in the interior of the power tool housing. This means that the drive of the power tool can no longer be optimally cooled in cases of continuous operation at a high output. For purposes of protecting the drive as well as certain components, a control unit employs sensors to monitor the temperature of the power tool. If a critical temperature is reached or exceeded in the interior of the power tool, the control unit is able to switch off the drive of the power tool, thus countering the generation of heat by the drive. When the drive and the power tool are switched off, they can cool down in their entirety until the temperature has once again fallen below the critical value and the work can be resumed.

Such a power tool is described, for example, in German preliminary published application DE 4 238 564 A1. This application especially discloses an electric tool equipped with a suction device that is connected to an external vacuum source. Here, the vacuum source serves to generate a stream of cooling air that flows through the electric motor.

### SUMMARY OF THE INVENTION

A drawback of this approach according to the state of the art, however, is that the power tool requires a cooling period whose duration cannot be determined by the user, as a result of which the work with the power tool is interrupted for an indeterminable period of time. Moreover, when the power tool is switched off suddenly in case of overheating, it might be assumed that the power tool is altogether defective and, even though the power tool would be operational once again after having cooled off, it might be the case that work is not resumed with this assumedly “defective” power tool.

The present invention provides a method to control a power tool when a material is being worked, comprising the following steps:
the rotational speed of a drive of the power tool is set to a first value;
a first temperature value is measured;
the first temperature is compared to a pre-specified threshold value;
the rotational speed of the drive is reduced from the first value to a second value if the first temperature value exceeds the pre-specified threshold value for a pre-specified first period of time;
a second temperature value is measured;
the second temperature is compared to the pre-specified threshold value; and
the rotational speed of the drive is raised from the second value to the first value if the second temperature value has fallen below the pre-specified threshold value for a pre-specified second period of time.

According to another advantageous embodiment of the present invention, it can be provided that the threshold value is specified as a function of the ambient temperature around the power tool. This prevents, for instance, that the threshold value is set too low, which would cause it to be exceeded too soon or too quickly.

For purposes of informing users of the power tool that the value has exceeded or fallen below the pre-specified threshold value and in order to indicate to them that the power tool is functioning properly, it can be advantageous to indicate that the value has exceeded or fallen below the pre-specified threshold value by means of a data indicator on the power tool. In this context, the data indicator on the power tool can be in the form of an indicator element, a display, at least a light or else in the form of an acoustic signal emitter.

### BRIEF DESCRIPTION OF THE DRAWINGS

The present invention will be explained in greater detail below making reference to advantageous embodiments, whereby the following is shown:

FIG. 1: a side view of a power tool comprising a drive and a control unit; and

FIG. 2: a diagram of the inventive method to control a power tool when a material is being worked.

### DETAILED DESCRIPTION

Identical components are provided with the same reference numerals in the figures as well as in the description below.

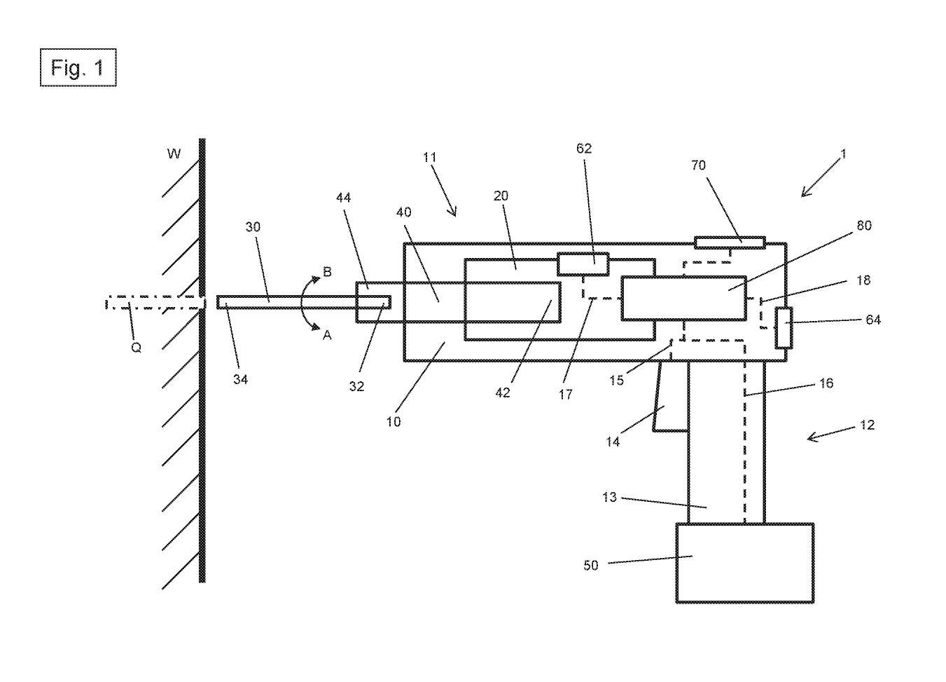

FIG. 1 shows a power tool 1 comprising a housing 10, a drive 20, a tool 30, a drive shaft 40, an energy source 50, a first temperature sensor 62, a second temperature sensor 64, a data indicator 70 and a control unit 80.

The housing 10 consists essentially of a first part 11 comprising the drive 20, the first temperature sensor 62, the second temperature sensor 64 and the control unit 80, as well as of a second part 12 comprising a handle 13, a switch 14 and the energy source 50. The switch 14 is connected to the control unit 80 via a line 15 so that the control unit 80 puts the drive 20 into operation when the switch 14 is actuated. Releasing the switch 14 causes the control unit 80 to halt the drive 20. Consequently, the control unit 80 serves primarily to control the drive 20.

The drive 20 is configured as an electric motor and the tool 30 is configured as a drill bit. The energy source 50 is configured as a battery. As an alternative, the energy source 50, however, can also be a power source (power socket) connected via a power cord. Neither the power cord nor the power source is shown in the figures. The energy source 50 supplies the drive 20 with power via a line 16.

The drive shaft 40 has a first end 42 and a second end 44, whereby the first end 42 is connected to the drive 20—which is configured as an electric motor—in such a way that a torque generated in the electric motor 20 is transmitted to the tool 30, which is configured as a drill bit. The drill bit 30 is connected at its first end 32 to the second end 44 of the drive shaft 40. The drive 20 and the drive shaft 40 cause the drill bit 30 to rotate in the direction of either arrow A or arrow B. A second end 34 of the drill bit 30 serves to drill a hole Q into the material W. Examples of the material W are concrete, stone, wood or the like.

The data indicator 70 is positioned on the first part 11 of the housing 10 and it is configured in the form of a display. The user (not shown here) of the power tool 1 can read data, parameters and information pertaining to the power tool 1 off the data indicator 70, which is configured here as a display.

The first temperature sensor 62 is connected to the electric motor 20 in such a way that it can continuously measure the temperature of the electric motor 20. Moreover, the first temperature sensor 62 is also connected to the control unit 80 via the line 17, so that said temperature sensor 62 can transmit the measured temperature values to the control unit 80.

The second temperature sensor 64 is connected to the housing 10 of the power tool 1 in such a way that it can measure the ambient temperature. Here, the second temperature sensor 64 is connected to the control unit 80 via a line 18. The measured temperature values can be sent to the control unit 80 via the line 18.

Threshold values are stored in the control unit 80 and, when they are compared to the measured temperature values, the control unit 80 can ascertain any critical temperature developments in the power tool 1. The threshold values are specified as a function of the appertaining ambient temperature around the power tool 1, which is measured by the second temperature sensor 64. This means that, at a low ambient temperature, the threshold values are selected and specified so as to be fairly low. In contrast, at high ambient temperatures, the threshold values are selected are specified so as to be fairly high.

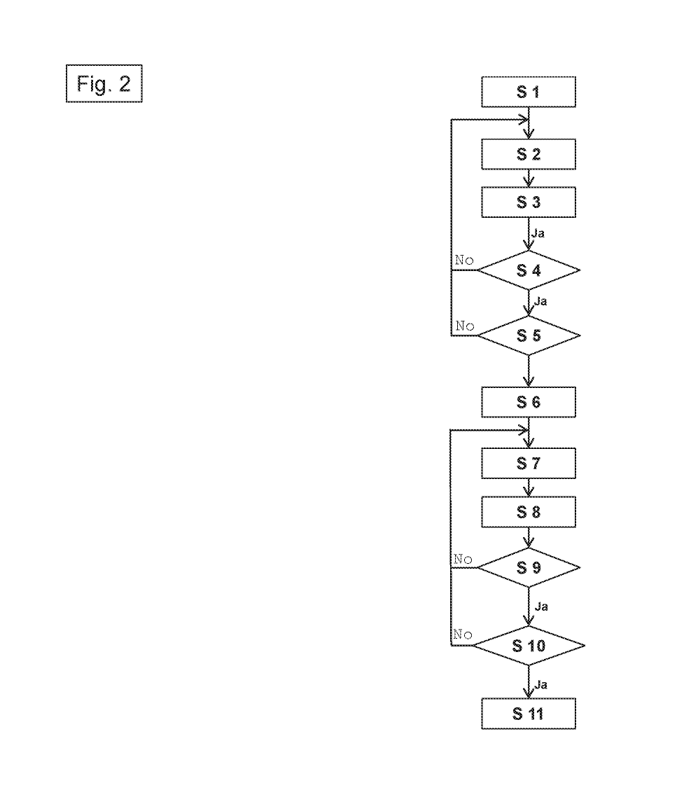

FIG. 2 shows a flow diagram of the method to control a power tool 1 when a material W is being worked.

First of all, in step S1, the rotational speed of the drive 20 is set to a value 1. In this context, the value 1 corresponds to a medium to high operating speed.

In step S2, a first temperature value of the drive 20 configured as an electric motor is measured by the first temperature sensor 62.

In step S3, the first temperature value of the drive 20 that was measured by the first temperature sensor 62 is compared to the pre-specified threshold value.

Then, in step S4, it is ascertained whether the first temperature value of the drive 20 has exceeded the threshold value or not.

If the threshold value has not been exceeded, the method is continued with step S2.

If the threshold value has been exceeded, this is followed by step S5 in which it is ascertained whether the threshold value has also been exceeded for a pre-specified first period of time.

If the threshold value has not been exceeded for the pre-specified first period of time, this is subsequently followed by step S2 once gain.

However, if it is ascertained that the threshold value has been exceeded for the pre-specified first period of time, this is followed by step S6 in which the rotational speed of the drive 20 is reduced from value 1 to a value 2. In this context, value 2 corresponds to a low operating speed.

The low operating rotational speed can achieve that, on the one hand, the drive 20 of the power tool 1 can cool off since the drive 20 is only drawing a small amount of power from the battery 50 and, on the other hand, it is possible to continue working with the power tool 1. Even though the rotational speed and thus the power output of the drive 20 are correspondingly reduced, the power tool 1 is not switched off completely, so that work at a slower pace is still possible.

Moreover, the momentary status of the power tool 1 can be shown to the user on the data indicator 70, which is configured as a display. In this manner, the user is informed that the power tool 1 is currently overheated and that the lower rotational speed is not the result of damage to the power tool 1, but rather, that the lower operating speed serves to let the drive 20 cool off and thus to prevent damage from occurring.

In this context, it should be noted that the length of the first period of time depends on the threshold value and on the ambient temperature around the power tool 1. This means that a long first period of time is selected and specified if the threshold value and the ambient temperature are fairly low. A short first period of time, in contrast, is specified if the threshold value and the ambient temperature are fairly high. A long first period of time can achieve that (if the threshold value and the ambient temperature are low) the rotational speed of the drive 20 is not prematurely reduced from value 1 to value 2 merely because a low threshold value was briefly exceeded. For purposes of working efficiently with the power tool 1 at a high rotational speed, a one-time and brief exceeding of the threshold value can be tolerated since, normally speaking, exceeding the threshold value briefly does not cause any damage to the power tool 1.

A short first period of time, in contrast, can achieve that (if the threshold value and the ambient temperature are high) the rotational speed of the drive 20 is reduced from value 1 to value 2 in time to prevent the possibility of any damage to the power tool 1 owing to high temperatures.

This is then followed by step S7, in which a second temperature value of the drive 20 is measured by the first temperature sensor 62.

In step S8, the second temperature value of the drive 20 that was measured by the first temperature sensor 62 is compared to the pre-specified threshold value.

Then, in step S9, it is ascertained whether the second temperature value of the drive 20 is still exceeding the threshold value or not any more.

If the second temperature value is still exceeding the threshold value, the method is continued with step S7.

If the second temperature value is no longer exceeding the threshold value, then, in step S10, it is ascertained whether a pre-specified second period of time was exceeded.

If the second temperature value of the drive 20 has not fallen below the threshold value for at least the second period of time, the method is likewise continued with step S7.

If, however, the second temperature value of the drive 20 has fallen below the threshold value for more than the second period of time, the method is continued with step S11. This means that the power tool 1 has now cooled off sufficiently again since it was operated at a lower rotational speed. In step S11, the rotational speed of the drive 20 is raised again from the lower value 2 (low operating speed) to the higher value 1 (medium to high operating speed).

What is claimed is:

1-3. (canceled)

4. A method for controlling a power tool when a material is being worked, comprising the following steps:
setting a rotational speed of a drive of the power tool to a first value;
measuring a first temperature value;
comparing the first temperature value to a pre-specified threshold value;
reducing the rotational speed of the drive from the first value to a second value if the first temperature value exceeds the pre-specified threshold value for a pre-specified first period of time;
measuring a second temperature value;
comparing the second temperature value is compared to the pre-specified threshold value; and
raising the rotational speed of the drive from the second value to the first value if the second temperature value has fallen below the pre-specified threshold value for a pre-specified second period of time.

5. The method as recited in claim 4 wherein the threshold value is specified as a function of an ambient temperature around the power tool.

6. The method as recited in claim 4 further comprising providing an indication that the value has exceeded or fallen below the pre-specified threshold value via a data indicator of the power tool.
